(19) United States
(12) Patent Application Publication
(10) Pub. No.: US 2012/0132042 A1
(43) Pub. Date: May 31, 2012

(54) MECHANICAL TORQUE WRENCH WITH AN ELECTRONIC SENSOR AND DISPLAY DEVICE

(75) Inventor: Michael Bruce, Atlanta, GA (US)

(73) Assignee: APEX BRANDS, INC., Sparks, MD (US)

(21) Appl. No.: 13/187,633

(22) Filed: Jul. 21, 2011

Related U.S. Application Data
(60) Provisional application No. 61/417,963, filed on Nov. 30, 2010.

(51) Int. Cl. B25B 23/144

(52) U.S. Cl. 81/479

(57) ABSTRACT

A mechanical torque wrench for engaging a workpiece, the torque wrench including a wrench body, a wrench head pivotably secured to the wrench body at a pivot joint and including a workpiece engaging portion and a bar extending therefrom, a hand grip, a set spring, a block disposed between a rear face of the bar and the set spring, an adjustment assembly for selecting a preset torque value, a resistive element producing a first output signal, a sensor producing a second output signal, and a processor for converting the first output signal into the preset torque value and converting the second output signal into an applied torque value. The application of a peak applied torque value to the workpiece causes the wrench head to pivot relative to the wrench body.

### CLAIM OF PRIORITY

This application claims priority to U.S. Provisional Patent Application No. 61/417,963 filed Nov. 30, 2010, the entire disclosure of which is incorporated by reference herein.

### FIELD OF THE INVENTION

The present invention relates generally to mechanical torque wrenches. More particularly, the present invention relates to mechanical torque wrenches including a device for maintaining the calibration of the wrench.

### BACKGROUND OF THE INVENTION

Often, fasteners used to assemble performance critical components are tightened to a specified torque level to introduce a “pretension” in the fastener. For example, high tensile-strength steel bolts used to fasten components of military vehicles, aerospace vehicles, heavy machinery, and equipment for petrochemical operations frequently have required torque specifications. As torque is applied to the head of the fastener, eventually, beyond a certain level of applied torque, the fastener actually begins to stretch. This stretching results in pretension in the fastener which then holds the joint together. Over-stressing fasteners can lead to their failure, whereas under-stressing fasteners can lead to joint failure, leakage, etc. Furthermore, in situations where gaskets are being utilized between the components being joined, an unequally stressed set of fasteners can result in gasket distortion and subsequent problems like leakage. Accurate and reliable torque wrenches help insure that fasteners are tightened to the proper specifications.

There are several types of mechanical torque wrenches that are routinely used to tighten fasteners to specified torque levels. Of these, clicker type mechanical torque wrenches are very popular. Clicker type mechanical torque wrenches make an audible click to let the user know when a preset torque level has been achieved and simultaneously provide a feeling of sudden torque release to the user.

One example of a clicker type torque wrench includes a hollow tube in which a spring and block mechanism is housed. The block is forced against one end of a bar that extends from a drive head. The bar and drive head are pinned to the hollow tube about a pivot joint and rotate relative thereto once the preset torque level is exceeded. The preset torque level is selected by a user by causing the spring to exert either greater or lesser force on the block. The force acts on the bar through the block to resist the bar's rotation relative to the hollow tube. As the torque exerted on the fastener exceeds the preset torque value, the force tending to cause the bar to pivot relative to the hollow tube exceeds the force exerted by the block preventing the bar's rotation, and the block “trips.” When released by the block's action, the bar pivots and hits the inside of the tube, thereby producing a click sound and a sudden torque release that is detectable by the user. Typically, to assist the user in setting the torque wrench, preset torque values are either permanently marked on a drum type scale that is visible through a window near or on the handle or marked on the tube itself. For most clicker type torque wrenches, the preset torque is set by rotating an adjuster sleeve on the handle, an end cap, or a thumb screw.

Another example of a clicker type torque wrench is a split beam mechanical torque wrench which measures the deflection of a deflectable beam relative to a non-deflectable beam, the deflectable beam causing a click once the preset torque is reached. These and other types of clicker type mechanical torque wrenches are popular since they are relatively easy to operate and make torquing relatively quick and simple. The user merely sets the preset torque value and pulls on the handle until he/she hears and feels the click and torque release indicating that the preset torque has been reached.

Several drawbacks limit the usage of clicker type torque wrenches. Often, these torque wrenches have permanently marked gauges that the user reads when setting the preset torque value. These gauges can be hard to read. The size of the markings is often small, and the resolution of the markings is often limited by the physical space available on the gauge.

Recalibration of existing clicker type torque wrenches, especially spring type clickers, often requires disassembling the unit to replace worn parts. Recalibration is often needed to correct the effect of the spring's characteristics and mechanical wear that occurs over time. Often, such wear cannot be compensated for without recalibration since, as previously noted, the gauges are most often permanently printed on the handle.

The present invention recognizes and addresses the foregoing considerations, and others, of prior art constructions.

### SUMMARY OF THE INVENTION

One embodiment of the present invention provides a mechanical torque wrench for engaging a workpiece, the torque wrench including a wrench body defining an elongated interior compartment, a wrench head including a workpiece engaging portion and a bar extending therefrom. The wrench head is pivotably secured to a first end of the wrench body at a pivot joint such that the bar extends into the interior compartment and the workpiece engaging portion extends outwardly from the wrench body. The wrench also includes a hand grip located on a second end of the wrench body, a set spring disposed within the interior compartment of the wrench body, a block disposed between a rear face of the bar and the set spring, an adjustment assembly for selecting a preset torque value to be applied by the mechanical torque wrench to the workpiece, a resistive element operatively coupled to the adjustment assembly and producing a first output signal, a sensor operatively coupled to the wrench head and producing a second output signal, the second output signal being proportional to an amount of torque being applied to the workpiece by the torque wrench, and a processor for converting the first output signal into the preset torque value and converting the second output signal into an applied torque value. The application of a peak applied torque value to the workpiece causes the wrench head to pivot relative to the wrench body about the pivot joint.

Another embodiment of the present invention provides a mechanical torque wrench for engaging a workpiece, the torque wrench including a wrench body defining an elongated interior compartment, a wrench head including a workpiece engaging portion and a bar extending therefrom. The wrench head is pivotably secured to a first end of the wrench body at a pivot joint such that the bar extends into the interior compartment and the workpiece engaging portion extends outwardly from the wrench body. The wrench also includes a hand grip located on a second end of the wrench body, an adjustment assembly for selecting a preset torque value to be applied by the mechanical torque wrench to the workpiece, a resistive element operatively coupled to the adjustment assembly and producing a first output signal, a strain gauge assembly operatively coupled to the wrench head and producing a second output signal, the second output signal being proportional to an amount of torque being applied to the workpiece by the torque wrench, and a processor for converting the first output signal into the preset torque value and converting the second output signal into an applied torque value. The application of a peak applied torque value to the workpiece causes the wrench head to pivot relative to the wrench body about the pivot joint.

Another embodiment of the present invention provides a mechanical torque wrench for engaging a workpiece, the torque wrench including a body, a head having a workpiece engaging portion and a bar extending therefrom. The head is pivotably secured to a front end of the body between the workpiece engaging portion and the bar. A set spring is disposed between the body and the bar so that the set spring exerts a selectable force therebetween so that, upon engagement of the workpiece engaging portion on the workpiece and application of a force on the body causing the body to apply a torque to the workpiece through the workpiece engaging portion and urge relative movement between the bar and the body, the wrench head resists the relative movement. An adjustment piece is disposed movably on the body in communication with the set spring so that selective movement of the adjustment piece relative to the body determines the force needed to reach a peak torque at which the relative movement occurs. A first sensor is in communication with the adjustment piece so that the selective movement of the adjustment piece changes a predetermined characteristic of a first signal output by the first sensor in a predetermined relationship to the force needed to reach the peak torque. A processor receives the first signal and the second signal, based on the second signal, detects occurrence of the relative movement, and compares the second signal at the occurrence and the first signal.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a top view of a mechanical clicker type torque wrench with an electronic sensor and display device in accordance with an embodiment of the present invention;

FIG. 2 is an exploded perspective view of the mechanical torque wrench as shown in FIG. 1;

FIG. 3 is a perspective view of a resistive element assembly of the mechanical torque wrench as shown in FIG. 1;

FIG. 4 is an exploded perspective view of the resistive element assembly of the mechanical torque wrench as shown in FIG. 1;

FIG. 5 is a partial cut-away top view of the mechanical torque wrench as shown in FIG. 1;

FIGS. 6A and 6B are partial cross-sectional views of the mechanical torque wrench as shown in FIG. 1, revealing the embodiment of the resistive element assembly shown in FIG. 3;

FIGS. 7A and 7B are partial cross-sectional views of the mechanical torque wrench as shown in FIG. 1, revealing an alternate embodiment of a resistive element assembly;

FIG. 8 is an electrical circuit of the electronics unit of the mechanical torque wrench as shown in FIG. 1;

FIG. 9 is a block diagram representation of the electronics unit of the mechanical torque wrench as shown in FIG. 1;

FIG. 10 is a block diagram representation of the electronics unit of the mechanical torque wrench as shown in FIG. 1;

FIG. 11 is a graphical representation of the calibration formula of the strain gauge assembly of the mechanical torque wrench as shown in FIG. 1;

FIG. 12 is a graphical representation of the calibration formula of the resistive element assembly of the mechanical torque wrench as shown in FIG. 1;

FIG. 13 is a flow chart of the control algorithm of the mechanical torque wrench as shown in FIG. 1;

FIG. 14 is a graphic representation of a torque applying operation when using the mechanical torque wrench as shown in FIG. 1; and

FIG. 15 is a view of a display device as used with the mechanical torque wrench as shown in FIG. 1.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

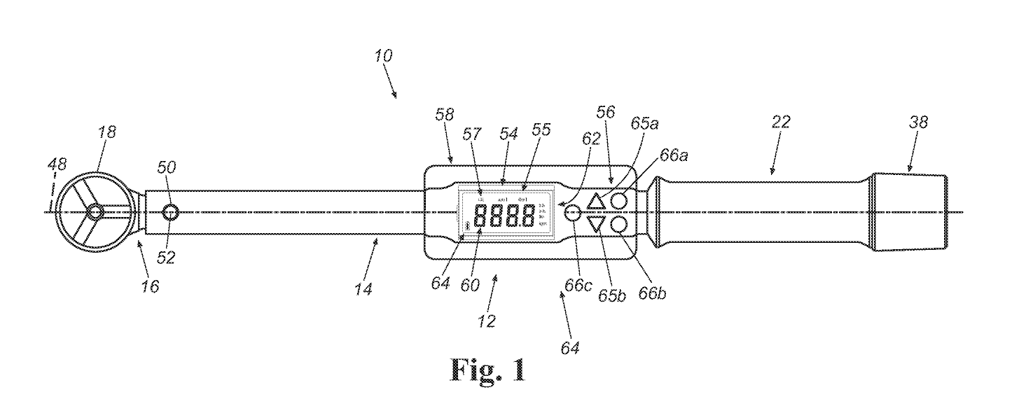

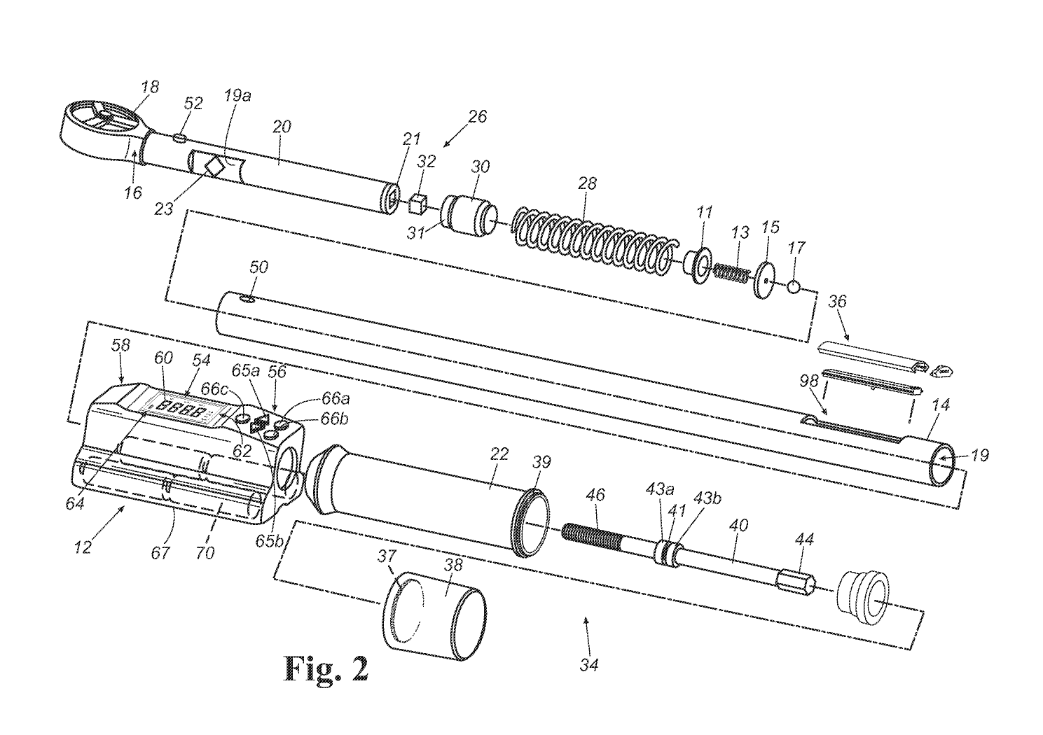

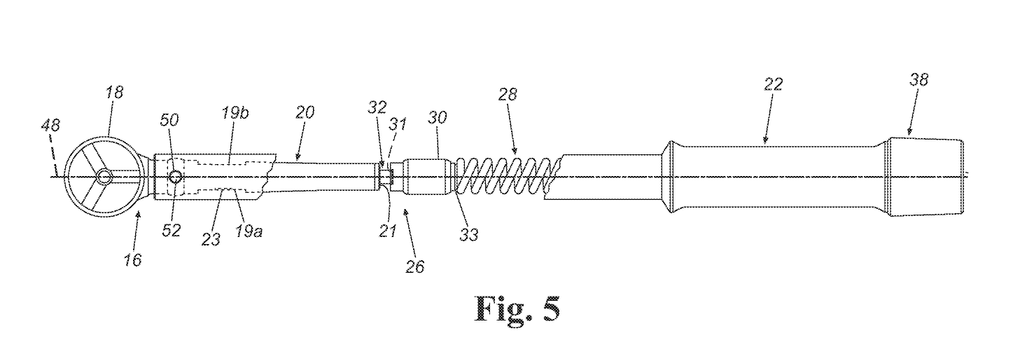

Referring now to FIGS. 1 and 2, a preferred embodiment of a mechanical clicker type torque wrench 10 with an electronics unit 12 includes an elongated wrench body 14, a wrench head 16 including a workpiece engaging end 18 and a bar 20 extending therefrom, a hand grip 22 fixed to one end of wrench body 14. Electronics unit 12, including a user interface, is received on wrench body 14 between the hand grip and wrench head 16. An interior compartment 19 of wrench body 14 houses a clicker mechanism 26 that includes a set spring 28, a plug assembly 30, a block 32, and bar 20, as best seen in FIG. 5. Block 32 is sandwiched between bar 20 and spring 28.

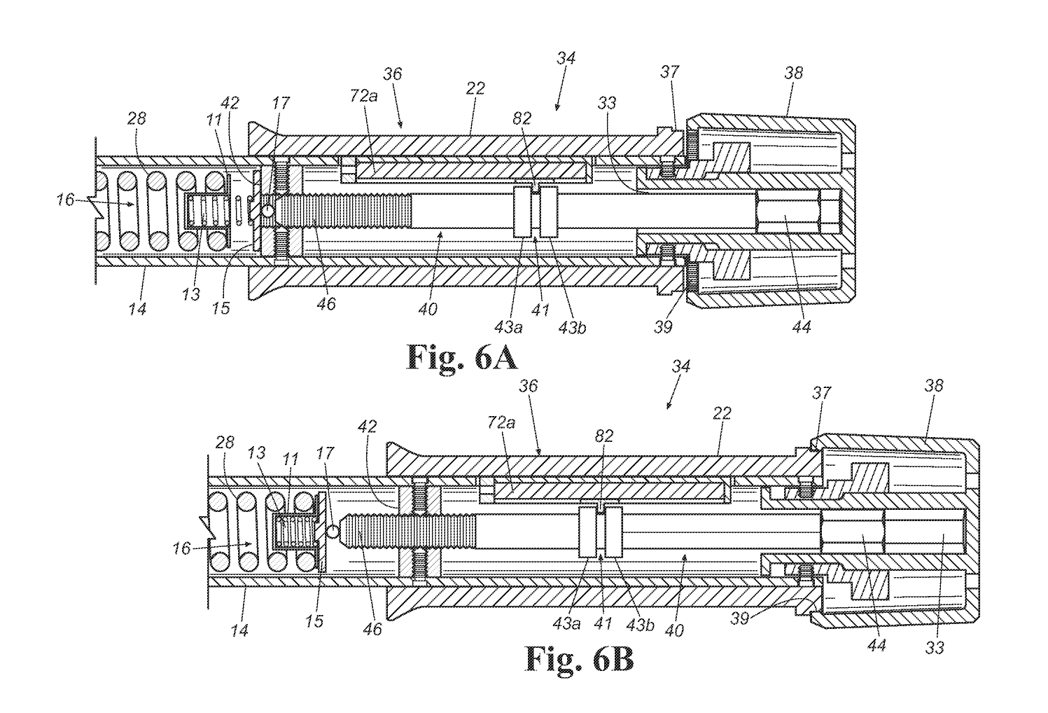

An adjustment assembly 34 is disposed on wrench body 14 opposite wrench head 16 for selectively adjusting a resistive element assembly 36 mounted to wrench body 14. Adjustment assembly 34 includes an end cap 38, a dial screw 40, and a nut 42 (FIG. 6A) fixed in interior compartment 19 of wrench body 14. End cap 38 engages a first end 44 of dial screw 40 and is selectively rotatable relative to wrench body 14. A second end 46 of dial screw is threaded and engages nut 42 such that rotation of dial screw 40 causes it to move axially along a longitudinal center axis 48 of wrench body 14. A spring cap 11 is received in the back end of set spring 28 and receives an engagement spring 13 therein. A thrust washer 15 abuts the rear end of engagement spring 13 and exerts force from dial screw 40 on set spring 28 via contact with spring cap 11 when the engagement spring is fully compressed therein, as discussed in greater detail below. A ball cam 17 is positioned between a front face of dial screw 40 and thrust washer 15.

Wrench head 16 is pivotably secured to a first end of wrench body 14 such that bar 20 extends inwardly into interior compartment 19 and workpiece engaging end 18 protrudes outwardly from wrench body 14. Wrench head 16 is secured to wrench body 14 at pivot joint 50 that includes a pivot pin 52 that is both perpendicular to longitudinal center axis 48 of wrench body 14 and transverse to a plane defined by torque wrench 10 as it is rotated during torquing operations about a workpiece to which engaging end 18 is engaged. Workpiece engaging end 18 may include a ratchet drive (not shown) so that torque may be selectively applied to a workpiece (not shown) in either the clockwise or counterclockwise direction. Wrench head 16 includes a pair of flat portions 19a and 19b (FIG. 5) on bar 20. Flat portions 19a and 19b are both transverse to the plane of rotation of torque wrench 10 and parallel to the longitudinal center axis of wrench head 16. A strain gauge assembly 23 is received on at least one of flat portions 19a and 19b, that being flat portion 19a in the embodiment shown. Note, however, a strain gauge assembly (not shown) can be positioned on the other flat portion 19b in alternate embodiments. In the preferred embodiment, strain gauge assembly 23 is a full-bridge assembly including four separate strain gauges on a single film that is secured to flat portion 19a of wrench head 16. An example of one such full-bridge strain gauge assembly is Model No. N2A-S1449-1KB manufactured by Vishay Micromeasurement, Malvern, Pa., United States. Together, the full-bridge strain gauge assembly mounted on the flat portion of the wrench head is referred to as a strain tensor.

As shown, electronics unit 12 is disposed on wrench body 14 between wrench head 16 and hand grip 22. Electronics unit 12 includes a user interface having a visual display 54, preferably a liquid crystal display, and a user input device 56 that includes a bank of buttons. Visual display 54 and input device 56 are both supported on a printed circuit board (not shown) which is in turn supported by a housing 58, preferably formed of injection molded plastic. The printed circuit board additionally carries a microcontroller and any additional electronic components for operation of the electronics unit. Visual display 54 includes a numerical display 60 to assist a user in setting a preset torque for the torque wrench, a torque unit indicator 62 that displays the units of the preset torque, a battery level indicator 64 for displaying the condition of the batteries, a calibration indicator 57 and a calibration mode indicator 55, as discussed in greater detail below. As shown, input device 56 includes a power button 66a, a unit selector button 66b for choosing the units to be shown on visual display 54, a calibration mode selector button 66c for selecting a mode of calibration for the torque wrench, and increment/decrement buttons 65a and 65b, respectively. Further, housing 58 of electronics unit 12 has a flat bottom surface 67 that forms a stable platform for setting the torque wrench down when it is not in use. The housing also defines a battery compartment 70 that is external to interior compartment of wrench body 14.

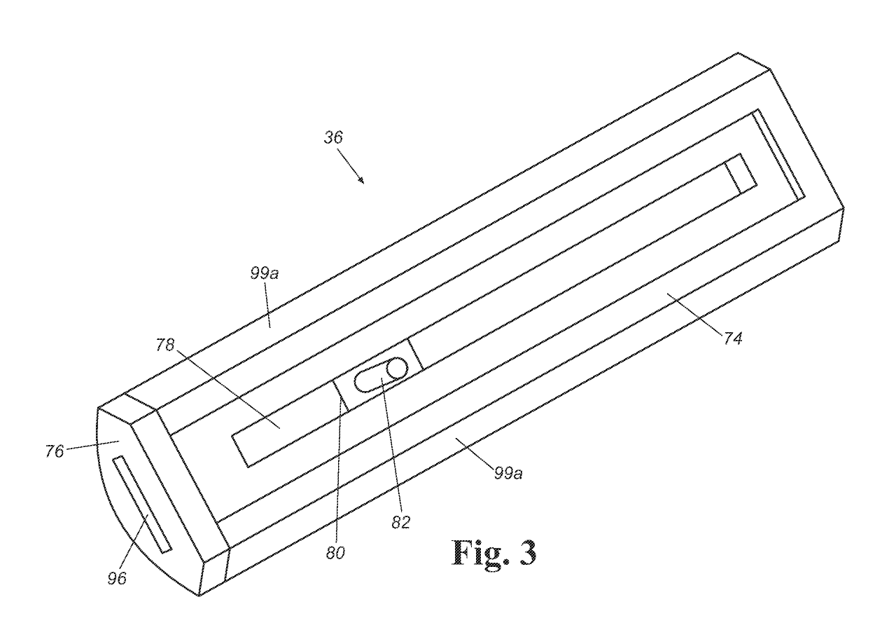

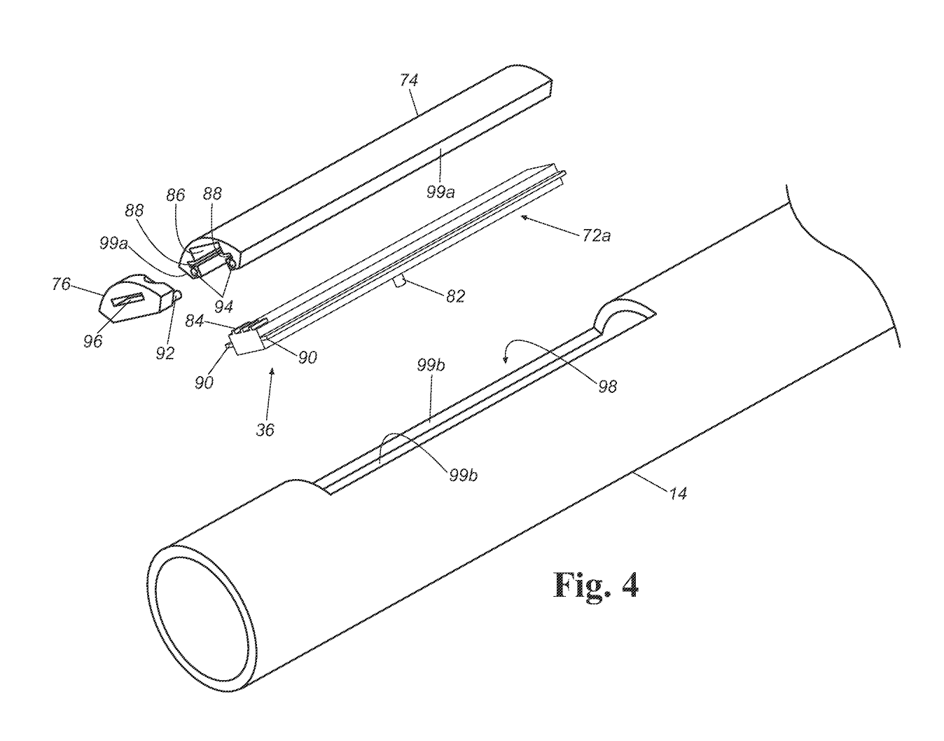

Referring now to FIGS. 3 and 4, resistive element assembly 36 includes a resistive element 72a, e.g., a potentiometer, a housing 74 and an end cap 76. As shown, the resistive element is a sliding potentiometer that includes a linear resistor 78, a wiper assembly 80 configured for motion along linear resistor 78, an adjustment pin 82 extending outwardly from wiper assembly 80 and terminal leads 84 for receiving wires from electronics unit 12. Motion of wiper assembly 80 along linear resistor 78 causes the overall resistance of sliding potentiometer 72a to vary, as discussed in greater detail below. Sliding potentiometer 72a is slidably received in a central recess 86 of housing 74. Axial recesses 88 extending outwardly from central recess 86 slidably receive axial guides 90 that extend outwardly from sliding potentiometer 72a to insure proper positioning of the potentiometer within housing 74. After linear potentiometer 72a is positioned in housing 74, end cap 76 is secured to housing 74 by inserting mounting pins 92 extending from end cap 76 into pin apertures 94 formed on housing 74 in a press-fit. End cap 76 includes a lead aperture 96 that allows wires from electronics unit 12 to pass therethrough so they may be connected to terminal leads 84 on sliding potentiometer 72a. Once assembled, resistive element assembly 36 is mounted in an aperture 98 defined by wrench body 14. Housing 74 and aperture 98 include corresponding pairs of axially extending abutment surfaces 99a and 99b, respectively, such that when housing 74 is mounted in aperture 98, the outer surfaces of housing 74 and wrench body 14 provide a smooth cylindrical surface.

As best seen in FIG. 5, block 32 of clicker mechanism 26 is substantially cube-shaped and is disposed between a rear face 21 of slender bar 20 and a forward face 31 of plug assembly 30. Forward face 31 of the plug assembly is slightly recessed and the recess has a shape similar to that of the surface of block 32 which rests against it. Recessed forward face 31 is also shaped correspondingly to an outer surface of block 32 so that the vertical longitudinal center axis of block 32 remains perpendicular to a plane defined by longitudinal center axis 48 as torque wrench 10 is rotated. As such, block 32 functions properly when the preset torque value is reached, as discussed in greater detail below. A rearward face 33 of plug assembly 30 receives the front end of set spring 28. Plug assembly 30 has an outer surface dimensioned sufficiently close to the inner diameter of body 14 (i.e. interior compartment 19) so that the plug assembly 30 is slidably received within interior compartment 19 of wrench body 14 yet is limited to minimal transverse motion relative to wrench body 14.

Referring now to FIGS. 6A and 6B, end cap 38 of adjustment assembly 34 is selectively rotatable relative to hand grip 22, and therefore wrench body 14. End cap 38 includes an annular array of locking teeth 39 formed about its forward inner perimeter that is selectively engageable with an annular array of locking teeth 37 formed about the rear outer periphery of hand grip 22. In a forward position (FIG. 6B) relative to hand grip 22, locking teeth 39 engage locking teeth 37 on hand grip 22, thereby rotationally fixing end cap 38 to wrench body 14. In a rearward position (FIG. 6A), locking teeth 39 are disengaged from locking teeth 37 on hand grip 22, and end cap 38 is therefore rotatable relative to wrench body 14.

End cap 38 includes an axial bore 33 that is configured to slidably receive first end 44 of dial screw 40. As shown, an outer surface of first end 44 of the dial screw and an inner surface of axial bore 33 define correspondingly-shaped hexagonal cross-sections such that end cap 38 is non-rotatable relative to dial screw 40. Second end 46 to dial screw 40 is threaded and received by correspondingly threaded nut 42 that is rotationally fixed inside inner compartment 19 of wrench body 14. As such, rotation of end cap 38, and therefore dial screw 40, relative to wrench body 14 causes dial screw 40 to translate axially along longitudinal center axis 48 of wrench body 14. The direction of axial motion is dependent on the direction of rotation of end cap 38 and causes dial screw 40 to either increase or decrease the torque value at which block 32 trips.

As best seen in FIG. 6A, when dial screw 40 is in the fully retracted position, engagement spring 13 exerts a forward biasing force on set spring 28 through spring cap 11. This forward biasing force insures that block 32 remains properly positioned between the forward face of plug assembly 31 and the rear face of bar 20 (FIG. 5) when dial screw 40 is fully retracted so as to minimize the compression of set spring 28. To preset a torque value from the fully retracted position, end cap 38 is rotated in a clockwise direction such that dial screw 40 moves toward set spring 28. In so doing, dial screw 40 urges thrust washer 15 forwardly until the thrust washer abuts spring cap 11 and engagement spring 13 is fully compressed therein. Continued rotation of end cap 38 causes thrust washer 15 to exert an increasing amount of force on set spring 28, thereby causing the amount of torque required to “trip” the torque wrench to similarly increase.

As shown, an annular groove 41 is formed about a central portion of dial screw 40 by a pair of radially outwardly extending shoulders 43a and 43b. Annular groove 41 is configured such that its fore and aft dimensions are substantially the same as the fore and aft dimensions of adjustment pin 82 of sliding potentiometer 72a. Annular groove 41 is configured to slidably receive adjustment pin 82 of sliding potentiometer 72a such that, as dial screw 40 is rotated in either direction and is translated along longitudinal center axis 48 of wrench body 14, adjustment pin 82 is engaged and moved by either radial shoulder 43a or 43b depending upon the direction of axial motion of dial screw 40, so that the overall resistance provided by sliding potentiometer 72a is altered dependent upon the position of wiper assembly 80 along linear resistor 78. Annular groove 41 is dimensioned and configured such that minimal friction is encountered as radial shoulders 43a and 43b are rotated relative to adjustment pin 82, and adjustment pin 82 is configured to have a smooth cylindrical outer surface. Unwanted vibrations that can possibly be transferred to the sliding potentiometer during use are minimized since dial screw 40 is threadedly received by nut 42, and thereby immobilized with respect to the wrench body. This feature helps to maintain a stable readout of the preset torque value on the display. Alternate embodiments of dial screw 40 may include an annular groove that extends radially inwardly into the body of dial screw 40 rather than being formed by a pair of radial shoulders 43a and 43b, as shown.

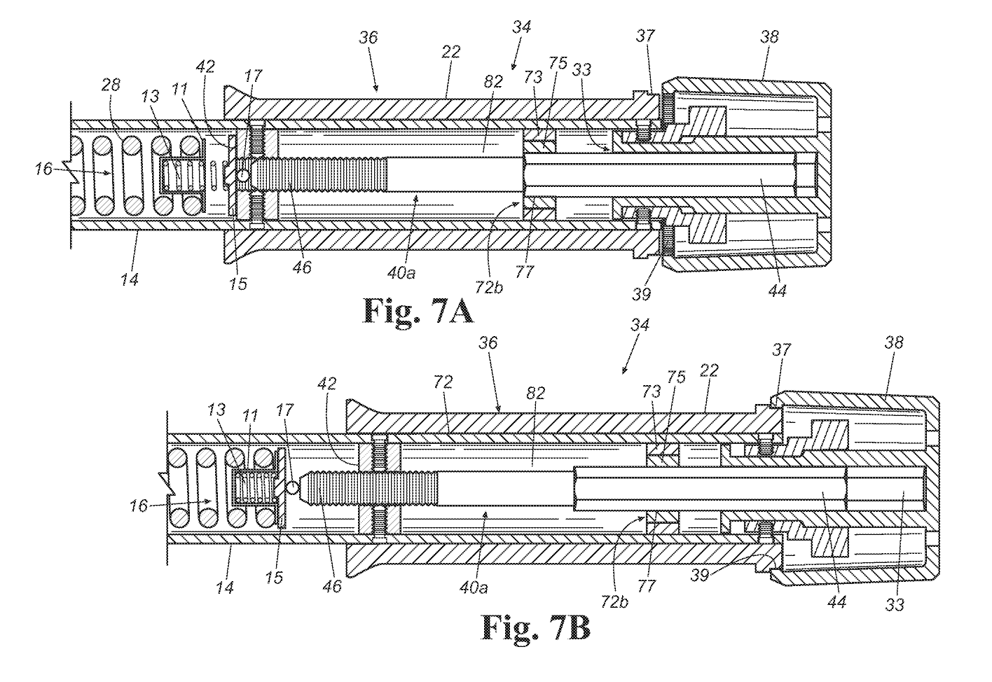

Referring now to FIGS. 7A and 7B, an alternate embodiment of a resistive element and dial screw is shown. The resistive element is an annular potentiometer 72b including an outer ring 73 that is rotationally fixed to inner compartment 19 of wrench body 14, an inner ring 75 that is rotatable relative to outer ring 73, and a central aperture 77 that is defined by inner ring 75 and configured to slidably receive a portion of dial screw 40a. As in the previously discussed embodiment, dial screw 40a includes a first end 44 having a cross-sectional shape that is complimentary to that of internal bore 33 of end cap 38, and second end 46 that is threadedly received in a nut 42 that is non-rotatably secured to interior compartment 19 of wrench body 14. However, rather than the previously discussed annular groove and adjustment pin arrangement, dial screw 40a has an extended hexagonally shaped first portion 44 that extends along the length of dial screw 40a such that it is received in the correspondingly shaped central aperture 77 of inner ring 75 of the annular potentiometer. As such, as end cap 38 is rotated relative to hand grip 22, thereby causing axial motion of dial screw 40a along longitudinal center axis 48 of wrench body 14, inner ring 75 of the annular potentiometer rotates relative to outer ring 73. Outer ring 73 includes a resistive element, and inner ring 75 includes a wiper assembly. Rotation of inner ring 75 relative to outer ring 73 causes the overall resistance of annular potentiometer 72b to either increase or decrease dependent upon the direction of rotation, i.e. clockwise or counter-clockwise, as previously discussed with respect to the sliding potentiometer.

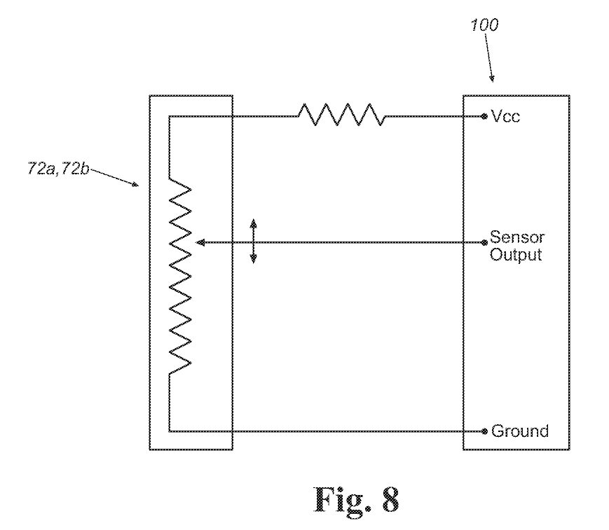

FIG. 8 illustrates a sensor electrical circuit 100 that determines the resistance of either sliding potentiometer 72a or annular potentiometer 72b in order to create an electrical signal for use by the microcontroller. Sensor electrical circuit 100 provides a fixed DC excitation voltage (Vcc) in the range of 3 to 5 volts that corresponds to a base preset torque value for the torque wrench. The voltage output of sensor electrical circuit 100 is proportional to the resistance of the potentiometer. As the adjustment assembly dial screw rotates, the potentiometer's resistance changes as the position of the wiper assembly 80 along linear resistor 78 changes, which in turn changes the sensor electrical circuit's output voltage. Because the output voltage is proportional to the resistance of the potentiometer, it is also proportional to the desired preset torque value being selected by the user.

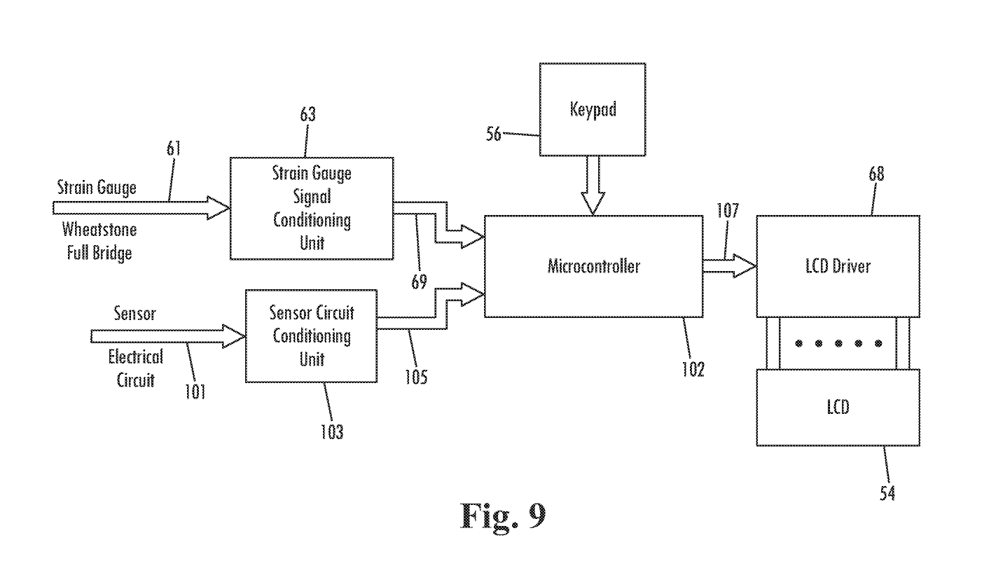

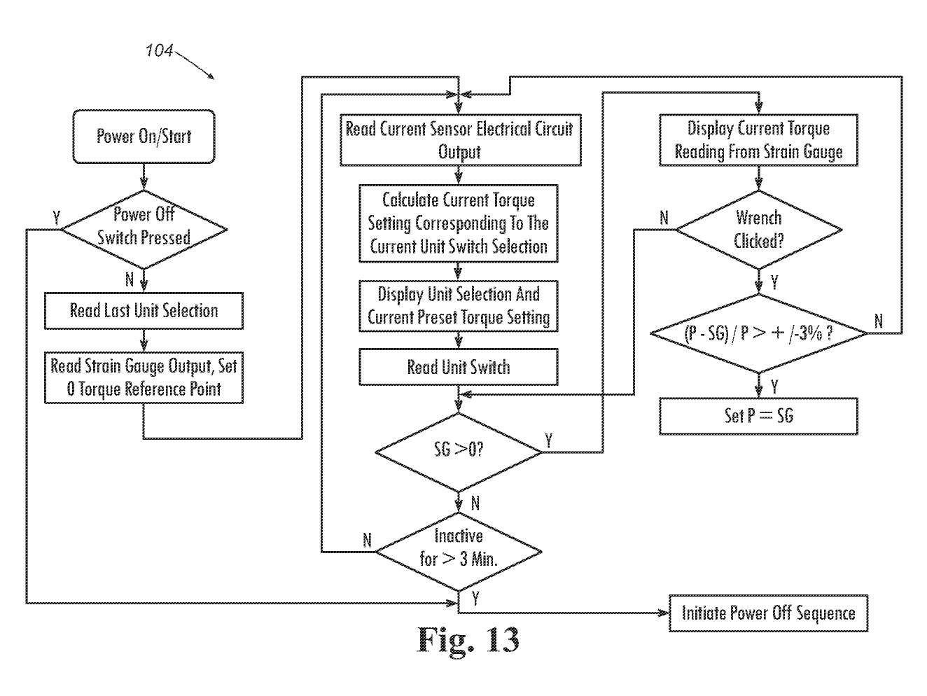

FIG. 9 illustrates a functional block diagram of the electronics unit of a torque wrench in accordance with one embodiment of the present invention. The analog output 101 from sensor electrical circuit 100 goes to a sensor circuit conditioning unit 103 that amplifies the signal and filters it to remove noise from the signal. An amplified and conditioned analog electrical signal 105 is then converted to an equivalent digital value by an analog to digital converter and fed to a processor, in this instance a microcontroller 102. A control algorithm 104 (FIG. 13) residing in microcontroller 102 is executed by the microcontroller to convert the equivalent digital value into an equivalent preset torque value. A conversion table may be stored in memory accessible by microcontroller 102 for this purpose. A unit conversion algorithm converts the preset torque value to the units (inch-pound, foot-pound, Newton-meter or kg-cm) selected by the user via the unit selector switch 66b (FIG. 1). The choice of units can be increased to cover all possible units by changing the appropriate algorithms, and falls with in the scope of this embodiment of the invention. An electrical signal 107 of the resulting digital preset torque value is then sent to a liquid crystal display driver 68 and the preset torque value is displayed on liquid crystal display 54 while the user is setting the desired preset torque value. Flash memory resides in microcontroller 102.

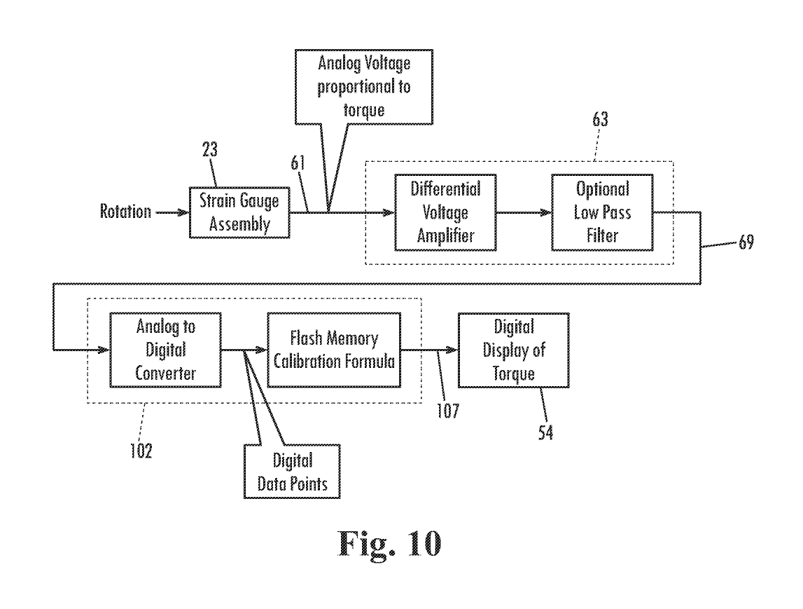

When electronic torque wrench 10 is used to apply and measure torque, strain gauge assembly 23 senses the torque applied to the fastener and sends an analog electrical signal 61 that varies in voltage proportionally to sensed torque to a strain gauge signal conditioning unit 63 that amplifies the signal and filters it for noise. An amplified and conditioned analog electrical signal 69 is then fed to microcontroller 102 that converts electrical signal 69 to an equivalent digital value and adjusts for any offset of the signal, as discussed in greater detail below with respect to FIG. 10. Adjusting for the offset of the signal increases the accuracy of the wrench by compensating the signal for any reading that may be present before torque is actually applied to the fastener. Microcontroller 102 (which may comprise a monolithic device or a collection of discrete digital and/or analog devices) utilizes control algorithm 104 to covert the equivalent digital value into an equivalent applied torque value. The unit conversion algorithm converts the applied torque value to the units selected by the user, and the resulting digital applied torque value is sent to liquid crystal display driver 68, and the applied torque value is displayed on liquid crystal display 54 so that the torque being applied to the fastener is displayed in real time. Various display technologies can be used and fall within the scope of the presently described embodiments, such as utilizing bar graphs, color coded graphs, LED patterns, etc. Preferably, the LCD includes a backlight to enhance the use of the torque wrench in dark regions, such as under the hood of an automobile.

As noted above, microcontroller 102 adjusts electrical signal 69 for any offset of the signal. When electronic torque wrench 10 is powered on, it is possible that strain gauge assembly 23 will produce an electrical signal 61 even though no torque is being applied with electronic torque wrench 10. Various conditions, such as, temperature, unintended deformation of the strain tensor, etc., can cause a no-load electrical signal to be present when the torque wrench is powered on, which can thereby introduce an error into subsequent torque measurements. As such, microcontroller 102 determines the value of the no-load electrical signal 69 when the torque wrench is powered on and subtracts this value from all subsequent electrical signals 69 received from strain gauge assembly 23 during torquing operations (until the next power-on event). Microcontroller 102 can adjust the received electrical signal 69 either prior to, or after, its conversion to an equivalent digital value by analog-to-digital converter 63. Since the conditions under which electronic torque wrench 10 are used can differ, microcontroller 102 determines the magnitude of the no-load electrical signal each time the electronic torque wrench is powered on and applies that value to that series of torquing operations that occur prior to powering off the electronic torque wrench.

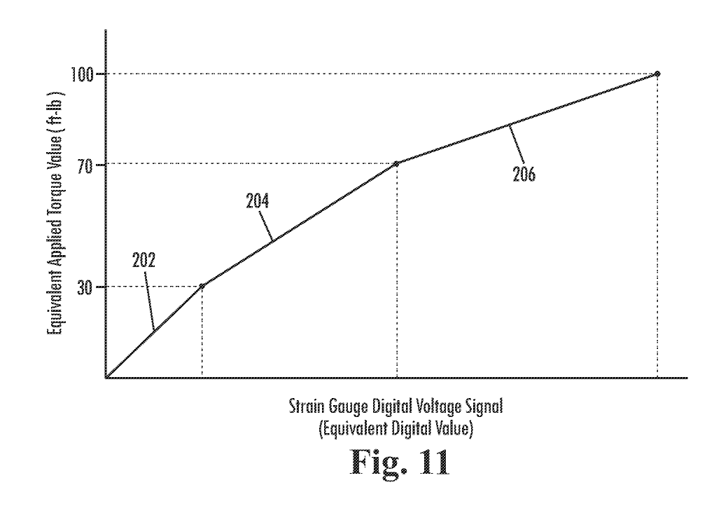

FIG. 11 is a graphical representation of the calibration formula utilized by microcontroller 102 to convert the equivalent digital values from strain gauge assembly 23 into equivalent applied torque values. Preferably, after assembly, each electronic torque wrench 10 is calibrated in order to derive its calibration formula. The electronic torque wrench is used to apply three known torque values at various points along the rated torque range of the torque wrench, those points being at 30%, 70% and 100% of the operating range maximum torque in the present embodiment. For example, for a torque wrench rated for torquing operations from 5.0 to 100.0 ft-lbs, 30.0, 70.0 and 100.0 ft-lbs of torque are applied with the electronic torque wrench and the equivalent digital value produced by the strain gauge at each torque is measured. The three data points provide three different graph segments (202, 204 and 206) of which the slopes (m) and y-intercepts (b) can be found using the equation y=m(x)+b. The formulas for the graph segments 202, 204 and 206 are stored in memory and used by microcontroller 102 to determine equivalent applied torque values based on the received equivalent digital values. The use of multiple graph segments allows microcontroller 102 to compensate for non-linearity that may be present across the operating ranges of some strain gauge assemblies. Alternate embodiments can have different numbers of graph segments, including as few as one.

For those instances where a lesser degree of accuracy is acceptable, the calibration formula of a single electronic torque wrench can be used in each torque wrench of the same design that utilizes the same model strain gauge assembly. This negates the need to calibrate each individual torque wrench. Additionally, alternate embodiments may include as few as one graph segment when it is determined that it is not necessary to compensate for the potential non-linear operation of the strain gauge assembly.

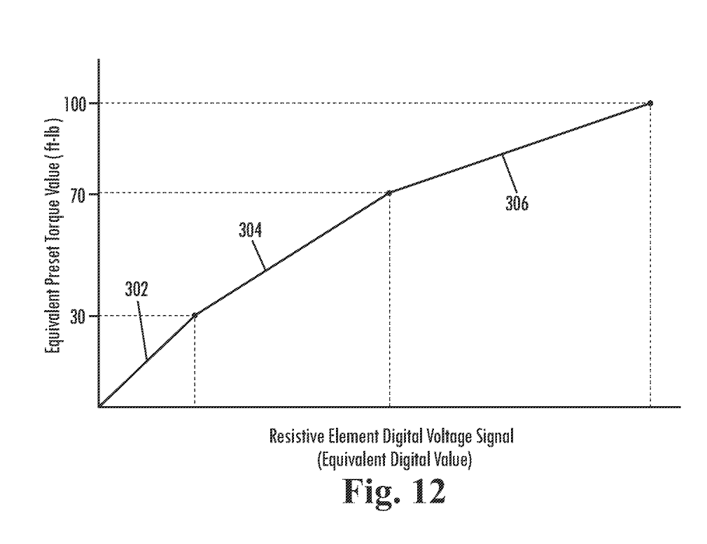

Similarly, the control system of the torque wrench also allows for the initial calibration of the resistive element assembly of the wrench. FIG. 12 is a graphical representation of the calibration formula utilized by microcontroller 102 to convert the equivalent digital values from resistive element assembly 36 into equivalent preset torque values. The unit can remain assembled, and the calibration is programmed into the control algorithm software. Initially, to calibrate the resistive element assembly of the torque wrench, the voltage output signals of sensor electrical circuit 100 (FIG. 8) are measured for at least two known torque values, preferably three, at which the torque wrench trips, as discussed above, thereby indicating the desired torque has been reached. Because the values of the voltage output signals are known that correspond to known torque values at which the wrench tripped, the “slopes” of the graph segments (302, 304 and 306) for the voltage output of the sensor electrical circuit versus the desired preset torque values can be calculated using the equation y=m(X)+b, as discussed previously. The formulas for the graph segments are then recorded into the memory, which is accessible by microprocessor 102, and used to determine desired preset torque values based on the received equivalent digital values.

FIG. 13 illustrates the highest level functional control algorithm 104 that controls the operations of the torque wrench. To use the torque wrench, the user switches on electronics unit 12 by pressing power button 66a. When powered on, the electronics unit first reads the selected units from the flash memory (saved before last powering off) and then reads strain gauge assembly 23 output signal prior to the application of torque and sets the zero torque reference point for the strain gauge assembly accordingly. Next, the processor reads the currently set preset torque value from the current sensor electrical circuit 100 output analog signal. The electronics unit converts the analog signal to a digital value that is then converted to an equivalent preset torque value based on the units that were either read from the flash memory when the wrench was powered on or subsequently selected by the user with unit selector button 66b after powering on the wrench. The preset torque value is then displayed as well as the selected units on the LCD. After selecting the desired preset torque value, the user may now apply torque to a fastener.

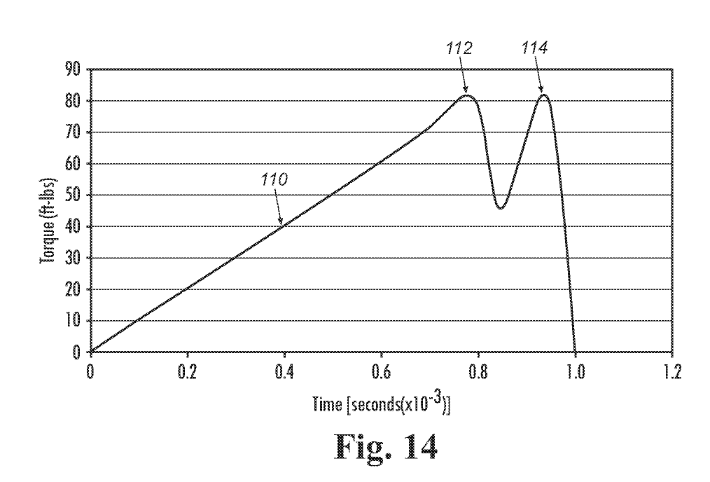

Referring additionally to FIG. 11, as the user begins to apply torque to the fastener, the microcontroller reads the current strain gauge assembly 23 output analog signal, thereby determining the actual torque being applied by the wrench at that moment. The microcontroller converts the analog signal to a digital value that is then converted to an equivalent applied torque value based on the selected units. The currently applied torque value is displayed, as well as the selected units, on the LCD rather than the preset torque value that was displayed prior to the application of torque to the fastener. In this manner, the user is aware of the actual torque being applied to the fastener in real time. For the example represented in FIG. 14, the preset torque value of the mechanical wrench was selected as 80 ft-lbs. As shown by section 110 of the graph, the amount of torque applied to the fastener increases until clicker mechanism 26 (FIG. 2) trips, as represented by peak 112 of the graph. Upon clicker mechanism 26 tripping, the torque being applied to the fastener decreases rapidly until the rearward most portion of bar 20 strikes the inner surface of wrench body 14, at which point torque will again be applied to the fastener up until the time at which the user ceases to rotate the torque wrench, represented by peak 114 of the graph. The electronics unit determines the peak applied torque value (SG) at the moment 112 clicker mechanism 26 trips, as determined by the signal received from strain gauge assembly 23 at that time.

The electronics unit determines the peak applied torque value (SG) by detecting a sudden drop in the output signal from strain gauge assembly 23 followed by a sudden increase in the output signal. The sudden decrease and subsequent increase in the amount of torque being applied by the torque wrench occurs over an extremely brief span of time, such as 25 msec. Preferably, the torque wrench utilizes a time span that allows for only events in which the torque wrench “trips” to be detected, rather than detecting each ratcheting stroke of the wrench. More specifically, the reflexes of the wrench user are not fast enough to prevent bar 20 from striking wrench body 14 when the wrench trips in order to prevent the subsequent re-application of torque and corresponding second peak 114. As such, a short time span can be selected, such as 25 msec. The time span between subsequent strokes of a torquing operation that requires ratcheting action of the wrench is typically much greater than the span utilized by the wrench and, as such, the wrench does not falsely detect ratcheting operations when determining peak applied torque values (SG).

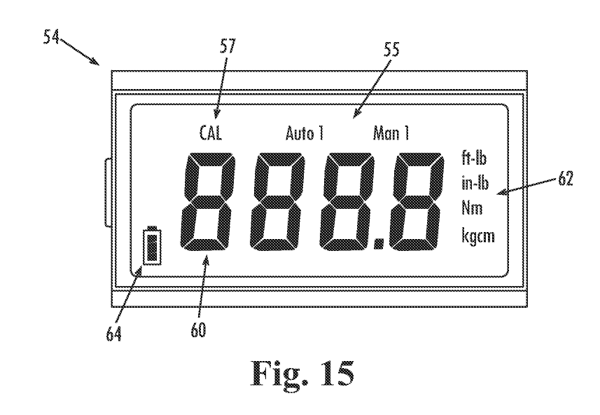

The control system of the presently-described embodiment allows for the continuous calibration of the resistive element assembly of the torque wrench. More specifically, the control system determines whether the difference between the peak applied torque (SG) and the preset torque value (P) falls within an acceptable range and, if not, recalibrates the torque wrench. As shown in FIG. 13, the control system determines what percentage of the preset torque value (P) the difference between the preset torque value and peak applied torque value (P−SG) is, and compares that percentage difference to a percentage value that is deemed acceptable for the operation of the torque wrench, in the instant case +/−3%. If the percentage difference falls outside the acceptable range, the control system reassigns the initial voltage output signal of sensor electrical circuit 100, that was set by the user of the wrench to select the desired preset torque value, to the peak applied torque value that corresponds to the voltage output signal of strain gauge assembly 23 at the time the torque wrench tripped 112. To insure the correction is applied across the entire operating range of the torque wrench, the control system adjusts the calibration formulas for the resistive element assembly accordingly. More specifically, referring again to FIG. 12, if the initial preset torque value (P) is 70.0 ft-lbs and the peak applied torque value (SG) at which the wrench trips is 80.0 ft-lbs, the initial voltage output signal of strain gauge assembly 23 is “reassigned” to 80.0 ft-lbs. Additionally, the control system similarly “reassigns” each voltage output signal of strain gauge assembly 23 to a peak applied torque value (SG) that is 10.0 ft-lbs greater than the preset value. In short, the control system “shifts” graph segments 302, 304 and 305 of the calibration formula to the left or right, as needed. The control system performs this function each time the torque wrench is used to apply torque to a fastener so that the torque wrench remains continuously within proper calibration. The currently described mode of calibration is the default calibration mode of the torque wrench and is indicated to the user by the display of “Auto 1” by calibration mode indicator 57 on visual display 54, as seen in FIG. 15.

A second automatic calibration mode is indicated by the display of “Auto 2” on calibration mode indicator 57. A user may select the second mode of automatic calibration by pressing calibration mode selector button 66c after powering on the torque wrench. The user then selects a given number of tripping events using increment/decrement buttons 65a and 65b that the torque wrench is to experience before recalibration. More specifically, if the user only wants the torque wrench to be recalibrated after every tenth time the torque wrench trips, he depresses increment button 65a ten times after selecting the second automatic calibration mode. Microcontroller 102 stores the peak applied torque value (SG) that is determined for each tripping event in memory until the tenth event occurs, at which time the control system utilizes the stored information to formulate a new calibration formula using known methods of fitting a graph to known data points.

In addition to automatic calibration modes, the torque wrench also allows the user to select manual calibration modes. A first manual calibration mode allows the user to select a desired number of tripping events to occur prior to the torque wrench indicating it is time to manually calibrate the torque wrench. When the user powers on the torque wrench, he presses the calibration mode selector button 66c until the torque mode indicator displays “Man 1”. Next, the increment/decrement buttons 65a and 65b are used to select the desired number of tripping events to occur prior to the torque wrench indicating that it is time to calibrate the wrench. Microprocessor 102 tracks the number of times the torque wrench trips during torquing operations, and calibration indicator 57 displays “CAL” when the selected number of events is reached. At this time, the user selects the second calibration mode by pressing the calibration mode selector button 66c at which time calibration mode indicator 55 displays “Man 2”. The user may now calibrate the torque wrench as previously discussed with regard to FIGS. 11 and 12.

A third manual calibration mode of the torque wrench is indicated by the display of “Man 3” on calibration mode indicator 55. In this mode, the control system determines whether the difference between the peak applied torque (SG) and the preset torque value (P) falls within an acceptable range when the torque wrench trips, as previously discussed with regard to the first automatic mode of calibration. If it is not, the torque wrench indicates it needs to be recalibrated by displaying “CAL” on calibration indicator 57. The user then selects the previously discussed second manual mode of calibration and recalibrates the wrench.

The algorithm also keeps track of the activity of the torque wrench. If the wrench is inactive for a predetermined period of time, the electronics unit shuts off the power to save battery life. Preferably, a predetermined period of three minutes is used. Regardless of whether the unit is switched off by manually pressing the power button or due to an inactivity-triggered auto shutoff, the microcontroller saves the unit selected in non-volatile memory (flash memory in the preferred embodiments). This feature allows the electronic unit to come on and display the last preset torque value and selected unit.

The two preferred embodiments of the mechanisms for converting the mechanical rotary dialing motion of the “set screw” into an equivalent electrical signal described herein are for illustration purposes only. It is envisioned that other embodiments may also use optical, magnetic, or capacitance based mechanisms as position sensors for the dial screw rather than the resistance-based mechanism discussed above. For example, magnetic sensors such as magnetostriction rods with ring wipers can be used. Similarly, optical scales and laser diode readers can be used, as can capacitance sensors having two sliding grid patterns with one stationary and the other movable to change the capacitance. Furthermore, the mechanical rotary motion of a thumb wheel used in split beam type mechanical torque wrenches falls within the scope of this invention. No matter what mechanism is used to generate the rotary motion, the methodology needed to convert the rotary motion to an equivalent electrical signal does not change from what is described in this invention. These and other like mechanisms that can be used to convert a mechanical rotary motion into an equivalent electrical signal are within the scope of this invention.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A mechanical torque wrench for engaging a workpiece, comprising:
a wrench body defining an elongated interior compartment;
a wrench head including a workpiece engaging portion and a bar extending therefrom, the wrench head being pivotably secured to a first end of the wrench body at a pivot joint, the bar extending into the interior compartment and the workpiece engaging portion extending outwardly from the wrench body;
a hand grip located on a second end of the wrench body;
a set spring disposed within the interior compartment of the wrench body;
a block disposed between a rear face of the bar and the set spring;
an adjustment assembly for selecting a preset torque value to be applied by the mechanical torque wrench to the workpiece;
a resistive element operatively coupled to the adjustment assembly and producing a first output signal;
a sensor operatively coupled to the wrench head and producing a second output signal, the second output signal being proportional to an amount of torque being applied to the workpiece by the torque wrench; and
a processor for converting the first output signal into the preset torque value and converting the second output signal into an applied torque value,
wherein application of a peak applied torque value to the workpiece causes the wrench head to pivot relative to the wrench body about the pivot joint.

2. The mechanical torque wrench of claim 1, wherein the processor compares the peak applied torque value to the preset torque value and reassigns the first output signal produced by the resistive element to the peak applied torque value.

3. The mechanical torque wrench of claim 1, wherein the processor determines the peak applied torque value by using the second output signal provided by the sensor.

4. The mechanical torque wrench of claim 1, the sensor further comprising a strain gauge assembly for indicating the applied torque value.

5. The mechanical torque wrench of claim 1, further comprising a user interface including a display.

6. The mechanical torque wrench of claim 5, wherein the preset torque value is displayed prior to the application of torque to the workpiece and the applied torque value is displayed while torquing the workpiece.

7. The mechanical torque wrench of claim 1, the adjustment assembly further comprising:
a dial screw threadably received within the interior compartment of the wrench body such that the dial screw moves along a longitudinal axis of the wrench body when rotated, rotation of the dial screw in a first direction compressing the set spring and rotation in a second direction allowing expansion of the set spring; and
a set ring positioned adjacent the hand grip, the set ring being operatively connected to the dial screw and rotatable relative to the wrench body,
wherein the resistive element is operatively coupled to the dial screw and produces the first output signal dependent on a position of the dial screw relative to the resistive element.

8. The mechanical torque wrench of claim 1, the resistive element further comprising a potentiometer fixed to the interior compartment of the wrench body.

9. The mechanical torque wrench of claim 8, the potentiometer further comprising a sliding potentiometer including a resistor and a wiper assembly, wherein movement of the dial screw along the longitudinal axis of the wrench body similarly moves the wiper assembly along the resistor such that the output signal is altered.

10. The mechanical torque wrench of claim 1, further comprising a plug assembly disposed between the block and the set spring, the block being adjacent a front face of the plug assembly and the rear face of the bar, the block being pivotal relative to the rear face and the front face.

11. The mechanical torque wrench of claim 2, wherein the workpiece engaging portion of the wrench head is a ratchet drive.

12. A mechanical torque wrench for engaging a workpiece, comprising:
a wrench body defining an elongated interior compartment;
a wrench head including a workpiece engaging portion and a bar extending therefrom, the wrench head being pivotably secured to a first end of the wrench body at a pivot joint, the bar extending into the interior compartment and the workpiece engaging portion extending outwardly from the wrench body;
a hand grip located on a second end of the wrench body;
an adjustment assembly for selecting a preset torque value to be applied by the mechanical torque wrench to the workpiece;
a resistive element operatively coupled to the adjustment assembly and producing a first output signal;
a strain gauge assembly operatively coupled to the wrench head and producing a second output signal, the second output signal being proportional to an amount of torque being applied to the workpiece by the torque wrench; and
a processor for converting the first output signal into the preset torque value and converting the second output signal into an applied torque value,
wherein application of a peak applied torque value to the workpiece causes the wrench head to pivot relative to the wrench body about the pivot joint.

13. The mechanical torque wrench of claim 12, wherein the processor compares the peak applied torque value to the preset torque value and reassigns the first output signal produced by the resistive element to the peak applied torque value and stores the reassigned first output signal in memory.

14. The mechanical torque wrench of claim 12, further comprising:
a set spring disposed within the interior compartment of the wrench body; and
a block disposed between a rear face of the bar and the set spring.

15. The mechanical torque wrench of claim 12, wherein the processor determines the peak applied torque value by using the second output signal provided by the sensor.

16. The mechanical torque wrench of claim 12, further comprising a user interface including a display, wherein the preset torque value is displayed prior to the application of torque to the workpiece and the applied torque value is displayed while torquing the workpiece.

17. The mechanical torque wrench of claim 12, the resistive element further comprising a potentiometer fixed to the interior compartment of the wrench body.

18. A mechanical torque wrench for engaging a workpiece comprising:
a body;
a wrench head having a workpiece engaging portion and a bar extending therefrom, the wrench head being pivotably secured to a front end of the body between the workpiece engaging portion and the bar;
a set spring disposed between the body and the bar so that the set spring exerts a selectable force therebetween so that, upon engagement of the workpiece engaging portion on the workpiece and application of a force on the body causing the body to apply a torque to the workpiece through the workpiece engaging portion and urge relative movement between the bar and the body, the wrench head resists the relative movement;
an adjustment piece disposed movably on the body in communication with the set spring so that selective movement of the adjustment piece relative to the body determines the force needed to reach a peak torque at which the relative movement occurs;
a first sensor in communication with the adjustment piece so that the selective movement of the adjustment piece changes a predetermined characteristic of a first signal output by the first sensor in a predetermined relationship to the force needed to reach the peak torque;
a second sensor in communication with the bar so that the torque applied by the wrench head to the workpiece changes a predetermined characteristic of a second signal output by the second sensor in a predetermined relationship to the torque; and
a processor that
receives the first signal and the second signal,
based on the second signal, detects occurrence of the relative movement, and
compares the second signal at the occurrence and the first signal.
